(19) United States
(12) Patent Application Publication
(10) Pub. No.: US 2015/0310764 A1
(43) Pub. Date: Oct. 29, 2015

(54) VISUAL AID FOR POLE DANCING

(71) Applicant: JACQUELYN S. ROGERS, San Jose, CA (US)

(72) Inventor: JACQUELYN S. ROGERS, San Jose, CA (US)

(21) Appl. No.: 14/264,055

(22) Filed: Apr. 29, 2014

(51) Int. Cl. G09B 19/00

(52) U.S. Cl. CPC G09B 19/0015

(57) ABSTRACT

A visual aid for pole dancing (also referred to as pole dance, pole exercise, pole fitness, or pole sport) situated on or around an exercise pole (also referred to as a dance pole or stripper pole). The visual aid for pole dancing has directional demarcations that are referenced to direct a person's body placement in executing skills, moves, or poses, while on or around an exercise pole.

### PRIORITY CLAIM

This application claims priority to U.S. Provisional Application No. 61/816,789, filed Apr. 28, 2013, now pending, the content of which is incorporated by reference herein in its entirety.

### BACKGROUND

1. Field of Invention

This invention relates to the field of pole dancing (also referred to as pole dance, pole exercise, pole fitness, pole sport). Specifically, a visual aid placed on or around an exercise pole (also referred to as a “dance pole” or “stripper pole”) that has directional demarcations and is used to direct a person's body placement in executing skills, moves, or poses, on or around an exercise pole.

2. Related Art

Pole dancing has evolved much since its origins as a form of adult entertainment commonly performed in strip clubs. Pole dancing has become a publicly acceptable form of exercise and sport, as well as entertainment.

Pole dancing consists of a series of skills, moves, or poses (sometimes referred to as “tricks and spins”) on or around an exercise pole. Skills, moves, and poses on or around an exercise pole focus on balance, strength, flexibility, endurance, and coordination. Skills, moves, and poses may be executed: 1) on the floor area around an exercise pole; 2) by swinging around an exercise pole with one or both feet touching the ground; 3) by spinning aerially on an exercise pole; or 4) by holding aerial poses and postures (sometimes referred to as “holds”), while on an exercise pole. Such skills, moves, and poses may be executed in an upright position, up side down, or in any other dimensional plane. Exact placement of the feet, hands, legs, arms, and other body parts changes from person to person and skill to skill depending on purpose and ability.

In a pole dancing session, one's body is moved in as many different directions and different combinations as equally and to the best of the person's ability as possible. Proper and consistent body placement and body alignment are key to: 1) a person's ability to successfully execute a skill, move, or pose; and 2) to preventing injury.

Pole dance instructors and students have a difficult time communicating desired body placement and directional orientation around or on an exercise pole. Very often, when a person goes up side down or experiences a spinning motion, they can become spatially disoriented. Additionally, instructors have a difficult time directing based on traditional right/left directions since a person uses their right arm when on the left side of an exercise pole, and a person uses their left arm when on the right side on an exercise pole.

Additionally, when pole skills, moves, or poses are executed by students on adjacent exercise poles, such as in a pole dancing class, students risk inadvertently colliding with one another when fellow students do not all safely move in the same direction and at the same speed, due to lack of direction.

Accordingly, a need remains for a visual aid for pole dancing, placed on or around an exercise pole, to overcome the above-noted shortcomings. The present invention satisfies such a need by providing a visual aid with directional demarcations to be used for directing proper and consistent body placement for skills, moves, or poses, on or around an exercise pole.

### SUMMARY

The Visual Aid for Pole Dancing is an aid used to guide, describe, and instruct a person on proper and consistent body placement when executing skills, moves, or poses, on or around an exercise pole. See drawing. The Visual Aid for Pole Dancing is used both in visual representation as well as through verbal instruction (with or without a visual representation). The utility patent of the Visual Aid for Pole Dancing covers all variations to design elements, including cardinal and ordinal direction, compass, clock face elements, ticks, celestial or Zodiac, colors, numbers, or representations of foot or body placement around an exercise pole; whether applied, painted or in material format, such as decals, mats or any other physical material situated on or around an exercise pole. This invention allows for variation in shape, material, construction method, attachment, and size. It is not intended that this description in any way limit its scope.

These and other features, aspects, and advantages of the present invention will become better understood with reference to the following description and claims.

### BRIEF DESCRIPTION OF THE DRAWINGS

The accompanying drawings, which are incorporated in and constitute a part of the specification, illustrate embodiments of the invention and, together with the description, serve to explain the objects, advantages, and principles of the invention. In the drawings:

FIG. 1 illustrates a perspective view of a visual aid for pole dancing situated around an exercise pole, according to one embodiment; and

FIG. 2 illustrates top plane view of directional demarcations to guide body placement, according to one embodiment.

Those skilled in the art will appreciate that the figures are not intended to be drawn to any particular scale; nor are the figures intended to illustrate every embodiment of the invention. The invention is not limited to the exemplary embodiments in the figures or the shapes, designs, relative sizes, or proportions shown in the figures.

### DETAILED DESCRIPTION

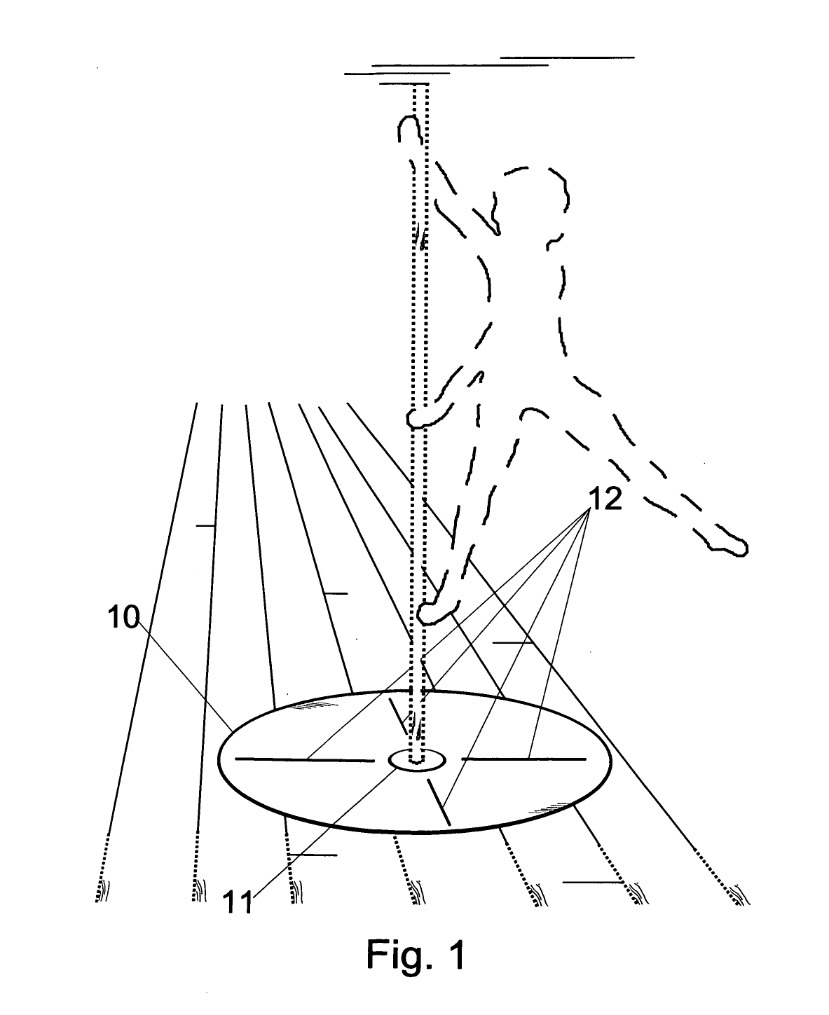

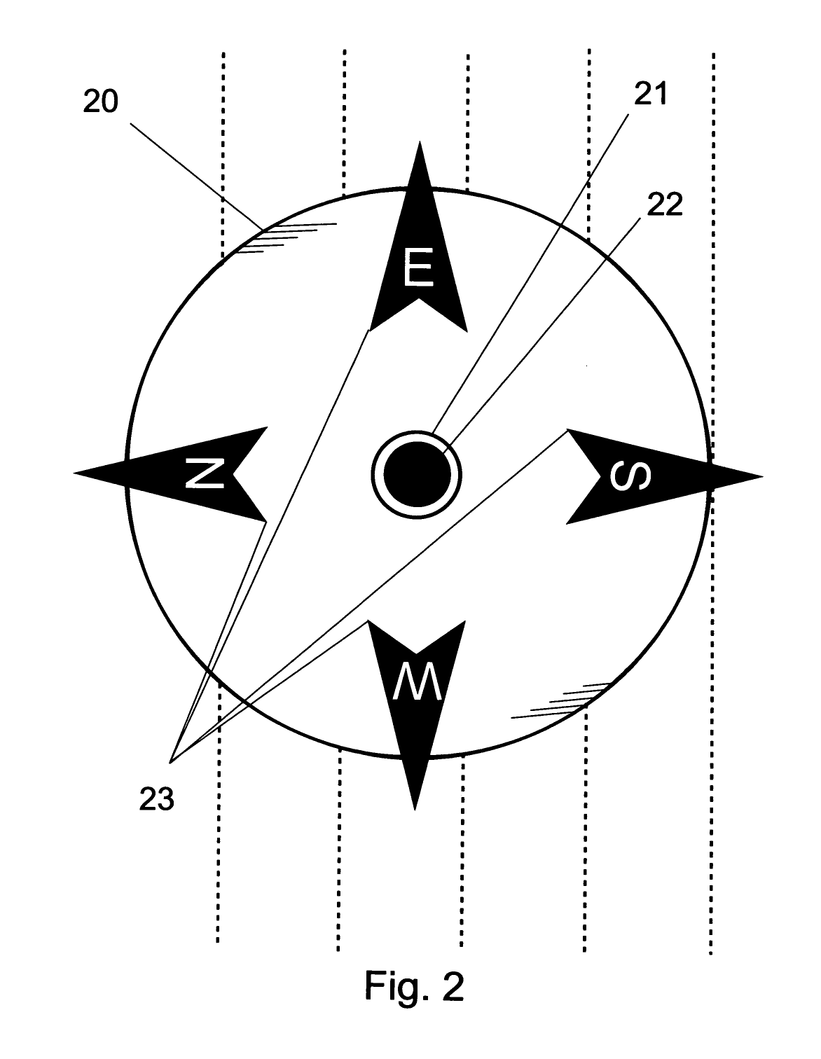

The visual guide for pole dancing in FIGS. 1 and 2 are illustrated for exemplary purposes only and it is to be understood that other designs and configurations can be created using the concepts taught by the invention while still providing the benefits thereof. As such, this detailed description of various alternative embodiments should not be construed to limit the scope or breadth of the present invention as set forth below.

As shown in the drawings (FIGS. 1 and 2) for purposes of illustration, the present invention is concerned with a visual aid for pole dancing 10 and 20, situated on or around an exercise pole, to facilitate proper placement of one's body parts, alignment, improvement, and fine tuning of skills, moves, or poses, 12 executed on or around an exercise pole 11 and 22.

The body placement demarcations and designs need be generic because persons are of different height, flexibility, and ability. The skills, moves, and poses, executed on or around an exercise pole are also very different in that sometimes: one, both, or neither feet are touching the ground; a person may be right side up, up side down, or in any other dimensional plane; a person may or may not be spinning; a person may be holding a static pose, swinging around, moving around, or vertically traversing an exercise pole; a person may hold on to an exercise pole with their hands, feet, legs, arms, or any other body part. The visual aid for pole dancing accommodates all body types and all skills, moves, and poses, depending on purpose and ability.

During a pole class, the visual aid for pole dancing is used to instruct students in safety and technique, and brings clarity to these concepts through visual and auditory reference. In this way, instructors can use the visual aid for pole dancing to ensure that students execute skills, moves, and poses, at the same time and speed so as to avoid colliding or otherwise harming fellow students on adjacent exercise poles.

In one embodiment, directional demarcations 12 assist a person in determining proper and consistent body placement, positioning, and alignment, on or around an exercise pole 11. Before the present invention, the body placement, positioning, and alignment, to execute skills, moves, and poses, executed on or around a pole, was a guessing estimate. Working with the directional demarcations, one can reference where he or she should position one's body.

In one embodiment, directional demarcations 12 allow for a person to orient oneself before, during, or after executing skills, moves, or poses, on or around an exercise pole. This is especially important since a person may become disoriented after spinning, while transitioning between moves, or when going up side down. Proper and consistent body placement on or around an exercise pole creates stability and therefore reduces the potential for bodily injury while executing skills, moves, or poses, on or around an exercise pole.

Now referencing FIG. 2, in one embodiment, the visual aid for pole dancing consists of ordinal directions 23 (namely north, south, east and west), located a radial distance 20 from and around the base 21 of an exercise pole 22.

In another embodiment, directional demarcations might include cardinal and ordinal direction, compass, clock face elements, ticks, celestial or Zodiac, colors, numbers, or representations of foot or body placement; whereas, directional demarcations may be situated symmetrically or asymmetrically on or around an exercise pole.

In another embodiment, visual aid will consist of at least one directional demarcation, but may consist of many demarcations. Example could include a mark referencing the twelve on a clock, with or without any other marks representing the other numbers, ticks, or clock elements.

In one embodiment, visual aid for pole dancing may be applied to the physical base 11 and 21 of an exercise pole 22, as a solid surface area around the base of an exercise pole, or at a radial distance from and around the base of an exercise pole.

In one embodiment, visual aid for pole dancing may be applied, painted, engraved, or in material format, such as decals, mats, floor or stages, or any other physical material situated on or around an exercise pole.

In one embodiment, visual aid for pole dancing can be used on any surface perpendicular to an exercise pole, such as placement on a floor, a ceiling, a stage surface, or a mat.

The preferred embodiment in FIG. 1 shows a circular shaped visual aid for pole dancing, but any shape, material, construction method, attachment, or size is permitted.

The preferred embodiment represented in FIG. 1 shows a visual aid for pole dancing, that is circular in shape, placed on the floor around the base of an exercise pole, with four directional demarcations spaced 90 degrees apart.

While certain embodiments have been described above, it will be understood that the embodiments described are by way of example only. Accordingly, the Visual Aid for Pole Dancing described herein should not be limited based on the described embodiments. Rather, the Visual Aid for Pole Dancing described herein should only be limited in light of the claims that follow when taken in conjunction with the above description and accompanying drawings.

After reading this description it will become apparent to one skilled in the art of how to implement the invention in various alternative embodiments and alternative applications. However, all the various embodiments of the present invention will not be described herein. It is understood that the embodiments presented here are presented by way of an example only, and not limitation. As such, this detailed description of various alternative embodiments should not be construed to limit the scope or breadth of the present invention as set forth below.

I claim:

1. A visual aid for pole dancing, comprising:
directional demarcations configured to aid a pole instructor or student to properly align one's body while executing moves, skills, or poses, on or around an exercise pole; wherein aid is placed on or around an exercise pole.

2. The aid of claim 1, wherein aid is positioned around an exercise pole, with or without radial separation from an exercise pole.

3. The aid of claim 1, wherein aid is situated on a horizontal surface perpendicular to the vertical exercise pole.

4. A method of utilizing a visual aid for pole dancing, comprising: directional demarcations configured to aid a pole instructor or student to properly align one's body while executing moves, skills, or poses, on or around an exercise pole; wherein aid is placed on or around an exercise pole.
